(19) United States
(12) Patent Application Publication
(10) Pub. No.: US 2023/0195240 A1
(43) Pub. Date: Jun. 22, 2023

(54) ELECTRONIC DEVICE, DISPLAY CONTROL METHOD AND STORAGE MEDIUM

(71) Applicant: CASIO COMPUTER CO., LTD., Tokyo (JP)

(72) Inventor: Hitoshi HIGAKI, Tokyo (JP)

(73) Assignee: CASIO COMPUTER CO., LTD., Tokyo (JP)

(21) Appl. No.: 18/068,166

(22) Filed: Dec. 19, 2022

(30) Foreign Application Priority Data
Dec. 21, 2021 (JP) 2021-207497

(51) Int. Cl. G06F 3/02; G06F 3/14; G06F 15/02

(52) U.S. Cl. CPC G06F 3/0219; G06F 3/14; G06F 15/0225

(57) ABSTRACT

A processor performs processing which includes inputting a plurality of mathematical formulas in response to operations performed on operation keys, displaying a list of the plurality of inputted mathematical formulas on a display, and displaying, in different display forms, a first mathematical formula which is a mathematical formula currently being inputted and a second mathematical formula which is a mathematical formula previously inputted, when displaying the list of the plurality of mathematical formulas.

### CROSS-REFERENCE TO RELATED APPLICATION

This application is based upon and claims the benefit of priority from the prior Japanese Patent Application No. 2021-207497, filed Dec. 21, 2021, the entire contents of which are incorporated herein by reference.

### BACKGROUND OF THE INVENTION

### 1. Field of the Invention

The present disclosure relates to an electronic device, a display control method and a storage medium.

### 2. Description of the Related Art

FIG. 9 is a schematic diagram showing a display method which has been adopted in conventional common scientific calculators. In this type of scientific calculators, a liquid crystal display which can display at a resolution of n×m dots is used, whereby mathematical formulas can be inputted and displayed, as shown in FIG. 9. In the case of computers, for example, it is common to display another window while working on some task and work this task in this state, as described in Japanese Patent Application Laid-Open (Kokai) Publication No. 2005-149440.

Accordingly, a scientific calculator is desired into which a plurality of mathematical formulas can be inputted, and which can display calculation results of the plurality of inputted mathematical formulas, respectively, on a liquid crystal display so as to enhance the user's convenience.

### SUMMARY OF THE INVENTION

In accordance with one aspect of the present invention, there is provided an electronic device comprising at least one processor configured to perform processing including: inputting a plurality of mathematical formulas in response to operations performed on operation keys; displaying a list of the plurality of inputted mathematical formulas on a display; and displaying, in different display forms, a first mathematical formula which is a mathematical formula currently being inputted and a second mathematical formula which is a mathematical formula previously inputted, when displaying the list of the plurality of mathematical formulas.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a block diagram showing the configuration of an electronic device 1 according to the present embodiment;

FIG. 2 is a front view showing the outer structure of the electronic device 1 according to the present embodiment;

FIG. 3 is a conceptual diagram showing a gray level displaying manner according to the present embodiment;

FIG. 4 is a flowchart showing operations (input operations) of the electronic device 1 according to the present embodiment;

FIG. 5 is also a flowchart showing operations (display operations) of the electronic device 1 according to the present embodiment;

FIG. 6 is a schematic diagram showing an example of a display method for the electronic device 1 according to the present embodiment;

FIG. 7 is also a schematic diagram showing an example of the display method for the electronic device 1 according to the present embodiment;

FIG. 8 is a schematic diagram showing an example of the input of mathematical formulas on the electronic device 1 according to the present embodiment; and

FIG. 9 is a schematic diagram showing a display method which has been adopted in conventional electronic devices.

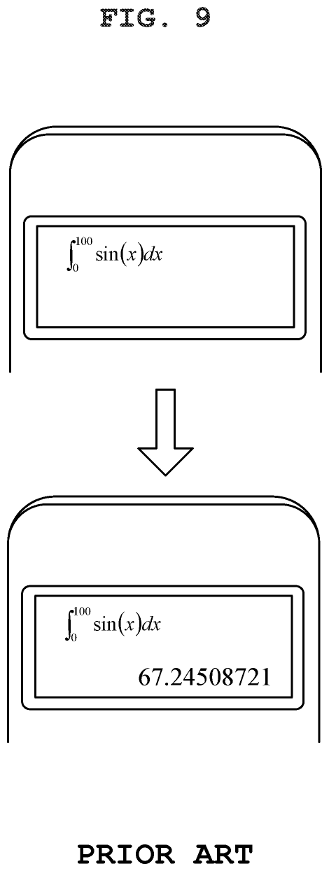

### DETAILED DESCRIPTION OF THE PREFERRED EMBODIMENTS

### A. Embodiment

A preferred embodiment of the present invention will hereinafter be described with reference to the drawings. Note that, although the embodiment described below is provided with various technically preferable limitations in order to carry out the present invention, these limitations are not intended to limit the scope of the present invention to the embodiment and examples shown in the drawings.

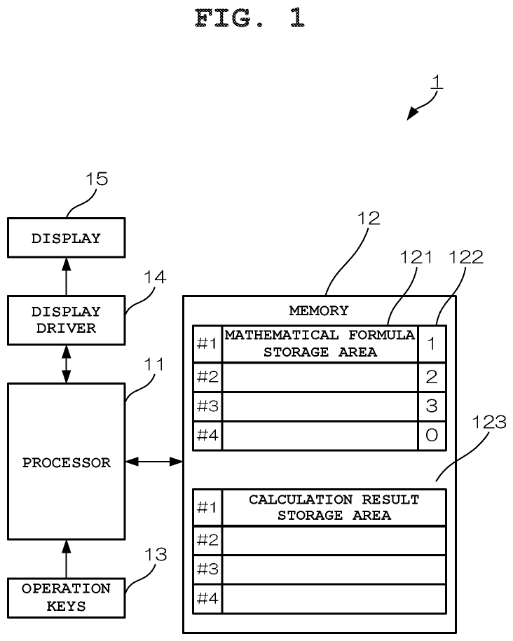

FIG. 1 is a block diagram showing the configuration of an electronic device 1 according to the present embodiment. This electronic device 1, which has a processor 11, a memory 12, operation keys 13, a display driver (DD) 14, and a display 15, may be a table-top calculator which is commonly called a calculator, or maybe one of various types of electronic devices other than calculators which has a function for calculating numerical values. Also, this electronic device 1 may have a configuration other than that shown in FIG. 1.

The processor 11, which controls various operations of the electronic device 1, may be a CPU (Central Processing Unit), an ASIC (Application-Specific Integrated Circuit), a FPGA (Field-Programmable Gate Array), or the like and may be constituted by two or more processors. This processor 11 operates as a judgment section for judging an operation manner related to a specific operation key among the operation keys 13. Also, this processor 11 operates as a control section for changing processing to be performed on the basis of an operation manner related to a specific operation key.

The memory 12 includes a RAM (Random-Access Memory) and a ROM (Read-Only Memory). The RAM, which is a volatile memory, is used as an operation memory for temporarily storing various types of data in the processor 11, a frame memory for displaying a plurality of inputted mathematical formulas (which may include functions, symbols, numerical values, decimal points, operators, and calculation results) on the display 15, and the like. On the other hand, the ROM, which is a non-volatile memory, has stored therein various types of programs such as a calculation program for actualizing various functions of the electronic device 1, various types of specific numerical values which are used as arguments in numerical calculation, and the like.

The operation keys 13 are various types of keys for a user to operate the electronic device 1. When an operation by an operation key 13 is accepted, an input signal according to the operation is transmitted to the processor 11.

The display driver 14 drives the display 15 under control of the processor 11. Also, the display driver 14 transmits various types of signals required for the driving of the display 15 to the display 15. The display 15 is a display device such as a liquid crystal display, and is capable of displaying at a resolution of n×m dots. Also, the display 15 performs various types of display related to a calculator function.

In particular, in the present embodiment, the processor 11 and the display driver 14 operate such that a plurality of mathematical formulas can be inputted in response to operations performed on the operation keys 13, the display area of the display 15 is divided into a plurality of areas (such as four lines), and mathematical formulas (which may include functions, symbols, numerical values, decimal points, operators, and calculation results) inputted into these areas acquired by the division are displayed. Also, the processor 11 operates such that, in mathematical formula input operations, a mathematical formula using a calculation result of another mathematical formula can be inputted.

Accordingly, in the present embodiment, the memory (RAM) 12 includes mathematical formula storage areas 121 (for example, four areas) for storing a plurality of mathematical formulas, and calculation result storage areas 123 for storing the calculation result of each mathematical formula, as shown in FIG. 1. Each mathematical formula storage area 121 is provided with a flag 122 indicating whether a mathematical formula in the corresponding area (line) is “unentered”, “active”, “semi-active”, or “inactive”. The “unentered” herein indicates that no mathematical formula has been inputted, the “active” indicates that a mathematical formula is being inputted, the “semi-active” denotes a mathematical formula whose calculation result has been used in another mathematical formula, and the “inactive” denotes a previously inputted (calculated) mathematical formula which is not “active” or “semi-active”. The processor 11 controls the status of each flag 122 in response to mathematical formula input operations performed on the operation keys 13 by the user, and controls the display status of each line in accordance with the status of the corresponding flag 122. In the present embodiment, the status of each flag 122 is displayed such that the line of “unentered” is “0”, the line of “active” is “1”, the line of “semi-active” is “2”, and the line of “inactive” is “3”. However, the present invention is not limited thereto.

By operating operation keys 13 (cursor keys), the user can set a mathematical formula in an arbitrary line to “activate”. Also, by operating an operation key 13 (REF key), the user can input a mathematical formula using a calculation result displayed in an arbitrary line. As described above, the processor 11 sets “unentered” (flag “0”) to a line where no mathematical formula has been inputted. When a new line is specified, the processor 11 automatically sets “active” (flag “1”) to this line, and changes “active” (flag “1”) set to a previously inputted (calculated) line to “inactive” (flag “3”). Also, the processor 11 changes “inactive” (flag “3”) to “semi-active” (flag “2”) for a line whose calculation result has been cited.

When displaying inputted mathematical formulas (which may include functions, symbols, numerical values, decimal points, operators, and calculation results) on the display 15, the processor 11 differentiates their display forms by varying their gray levels (four gray levels) in accordance with a predetermined rule. More specifically, the processor 11 controls such that a mathematical formula (which may include functions, symbols, numerical values, decimal points, operators, and calculation results) in an “active” field (line) is displayed in “black”, a mathematical formula in a “semi-active” field (line) is displayed in “dark gray”, a mathematical formula in an “inactive” field (line) is displayed in “light gray”, and a field where no mathematical formula has been inputted is unlit. As a result, by only viewing the display status of the display 15, the user can easily know a current input status on the basis of differences among the displayed gray levels. That is, the user can easily know whether a target field is “active” indicating that a mathematical formula is being inputted thereinto, “semi-active” indicating that a calculation result therein has been used in another mathematical formula, “inactive” indicating that a mathematical formula therein is a previously inputted (calculated) mathematical formula and the calculation result thereof has not been used in another mathematical formula, or “unentered”.

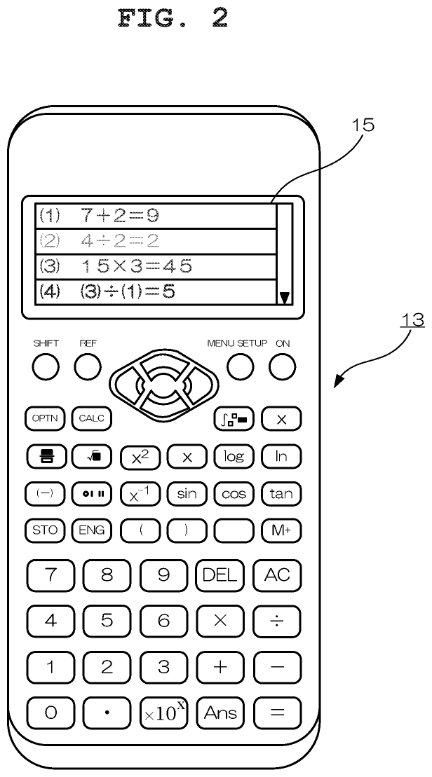

FIG. 2 is a front view showing the outer structure of the electronic device 1 according to the present embodiment. On the front of the housing of the electronic device 1, the operation keys 13 and the display 15 are provided, as shown in FIG. 2. The display 15 is configured such that a display area of 192×63 dots is divided into four areas, and an independent mathematical formula is displayed in each display area (line). In the example of the drawing, “7+2=9” has been inputted and displayed in the first line (1), “4±2=2” has been inputted and displayed in the second line (2), “15×3=45” has been inputted and displayed in the third line (3), and “(3)±(1) =5” has been inputted and displayed in the fourth line (4). Here, “(3)” in the fourth line (4) indicates that (the calculation result of) the mathematical formula in the third line has been cited, and “(1)” therein indicates that (the calculation result of) the mathematical formula in the first line has been cited. Note that, although details will be described later, two lines can be combined and used as one line when a complicated mathematical formula (whose display size is large) is displayed in the present embodiment.

In the example of the drawing, the mathematical formula in the fourth line is “active”, and therefore has been displayed in “black”. In addition, since the mathematical formula in the fourth line is using the third line and the first line, the mathematical formulas in the third line and the first line are “semi-active” indicating that they are being used by another mathematical formula (which is in the fourth line in this case), and therefore have been displayed in “dark gray”. Moreover, the mathematical formula in the second line is “inactive” indicating that it is a previously inputted (calculated) mathematical formula and has not been cited, and therefore has been displayed in “light gray”.

The operation keys 13 include numerical keys, functional, symbolic, and arithmetic keys, and function keys. The numerical keys, which are used to input numerical values, include keys corresponding to numerical values such as 0 to 9. The functional, symbolic, and arithmetic keys include, for example, function-symbol keys such as “log”, “ln”, “sin”, “cos”, and “tan” which are used when calculation formulas and function expressions are inputted, operator keys corresponding to operators such as “+” (addition), “−” (subtraction), “×” (multiplication), and “±” (division), and an equal key corresponding to “=” (instruction execution). The function keys, which are operated to use various functions of the electronic device 1, include a reference key (REF key), an all clear key (AC key), a clear key (C key), and memory keys (MRC key, M+ key, and M− key), for example.

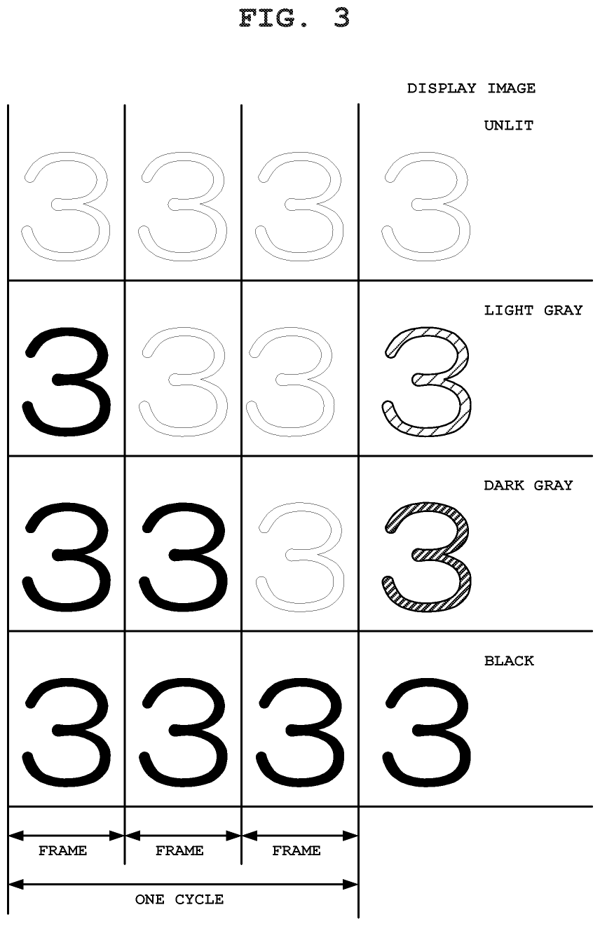

FIG. 3 is a conceptual diagram showing a gray level displaying manner according to the present embodiment.

In the present embodiment, mathematical formulas (which may include functions, symbols, numerical values, decimal points, operators, and calculation results) in the plurality of lines set in the display 15 are displayed such that their display forms are different from one another by their gray levels being varied (to be four gray levels) in accordance with the predetermined rule. This rule specifies that each line where no mathematical formula has been inputted is unlit, a mathematical formula which is currently being inputted is displayed in “black”, a previously inputted mathematical formula whose calculation result has been used in another mathematical formula is displayed in “dark gray”, and a previously inputted mathematical formula whose calculation result has not been used in other mathematical formulas is displayed in “light gray”. Accordingly, as an example, the FRC (Frame Rate Control) method is used. More specifically, ON and OFF is controlled for each frame of each line with three frames as one cycle. That is, each line is unlit (light is turned off) by all the three frames being unlit. In addition, by one of the three frames being lit, a mathematical formula therein is displayed in light gray. Moreover, by two of the three frames being lit, a mathematical formula therein is displayed in dark gray. By all of the three frames being lit, a mathematical formula therein is displayed in black. Note that, although light gray and dark gray are expressed by hatching in FIG. 3 for convenience of description and the difference therebetween is expressed by the density of the hatching being differentiated, each of them is displayed using a single color in practice. Also, although only an example of the numerical value “3” is shown in FIG. 3, mathematical formulas (which may include functions, symbols, numerical values, decimal points, operators, and calculation results) are also displayed in this manner.

Moreover, as an alternative to the FRC method, a method may be adopted in which RAM for two screens is provided and two gray levels of 0/1 are increased to four gray levels of 00/01/10/11, or a method may be adopted in which data in the RAM are divided into the data of lower-order bits and the data of higher-order bits so as to express four gray levels.

### B. Operations of Embodiment

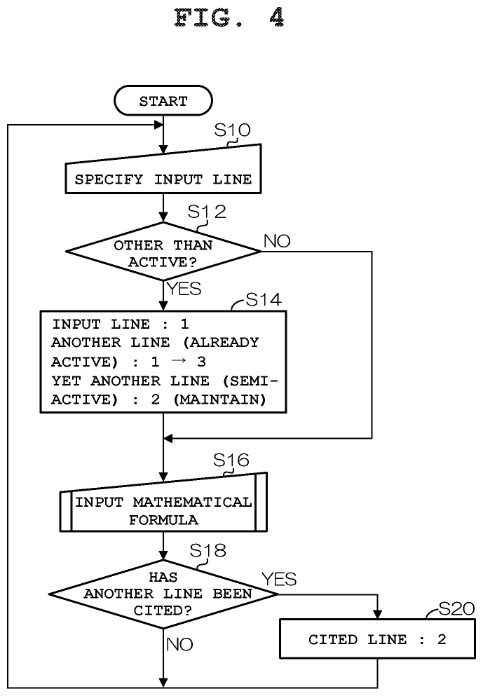

FIG. 4 is a flowchart showing operations of the electronic device 1 of the present embodiment when input is performed. First, the processor 11 accepts an operation which has been performed using the operation keys 13 so as to specify a line where a mathematical formula is inputted (Step S10). Here, the user specifies an arbitrary line by a cursor key or the like. Next, the processor 11 judges whether or not the specified input line is a line that is not active (not flag “1”) (Step S12). For example, in a case where a mathematical formula that is currently being inputted (active) is required to be corrected, or a case where a currently active line has been specified as an input line so as to input a new mathematical formula, its display form (the status of the flag) is not required to be changed. Conversely, when a line that is not active (not flag “1”) is specified, its display form (the status of the flag) is required to be changed.

When the specified input line is a line that is not active (not flag “1”) (YES at Step S12), the processor 11 sets the flag 122 of the mathematical formula storage area 121 corresponding to the specified input line to active (“1”), sets the flag 122 of another line that has been active (“1”) to inactive (“3”), and maintains the flag 122 of yet another line which has been semi-active (“2”) and whose calculation result has been cited so that this line remains as semi-active (“2”) (Step S14).

Here, further details of the input line are described below. When there is already a mathematical formula in the input line and the input line is active (“1”), the processor 11 maintains the input line as active (“1”). When there is already a mathematical formula in the input line but the input line is inactive (“3”), the processor 11 changes its state from inactive (“3”) to active (“1”). When the input line is semi-active (“2”) whose calculation result has been cited, the processor 11 changes its state from semi-active (“2”) to active (“1”). Then, the processor 11 proceeds to Step S16.

On the other hand, when the specified input line is not a line that is not active, that is, an active line (flag “1”) (NO at Step S12), the flags 122 of the mathematical formula storage areas 121 of this line and the other lines are not required to be changed, and therefore the processor 11 proceeds to the following Step S16 without performing any operation.

Next, the processor 11 accepts an operation of inputting a mathematical formula which is performed by use of the operation keys 13 (Step S16). Here, the user inputs a desired mathematical formula by use of the numerical keys and the functional, symbolic, and arithmetic keys of the operation keys 13. Then, the processor 11 judges whether or not the inputted mathematical formula includes a mathematical formula (calculation result) of another line (Step S18). When the inputted mathematical formula does not include any other mathematical formula (calculation result) (NO at Step S18), the processor 11 returns to Step S10 without changing the flags and repeats the above-described processing.

Conversely, when the inputted mathematical formula includes a mathematical formula (calculation result) of another line (YES at Step S18), the processor 11 sets the flag 122 of the mathematical formula storage area 121 corresponding to this cited line to semi-active (“2”) (Step S20). More specifically, when this cited line is inactive (“3”), the processor 11 changes its state from inactive (“3”) to semi-active (“2”). When this cited line is already semi-active (“2”), the processor 11 maintains its state as semi-active (“2”).

Here, although details of operations such as a calculation operation for calculating an inputted mathematical formula and an all clearing operation for deleting a mathematical formula are omitted in the above descriptions, one example is given below. When an all clearing operation is performed, the processor 11 performs operations such as processing for setting the flag 122 of the mathematical formula storage area 121 of the corresponding line to (“0”).

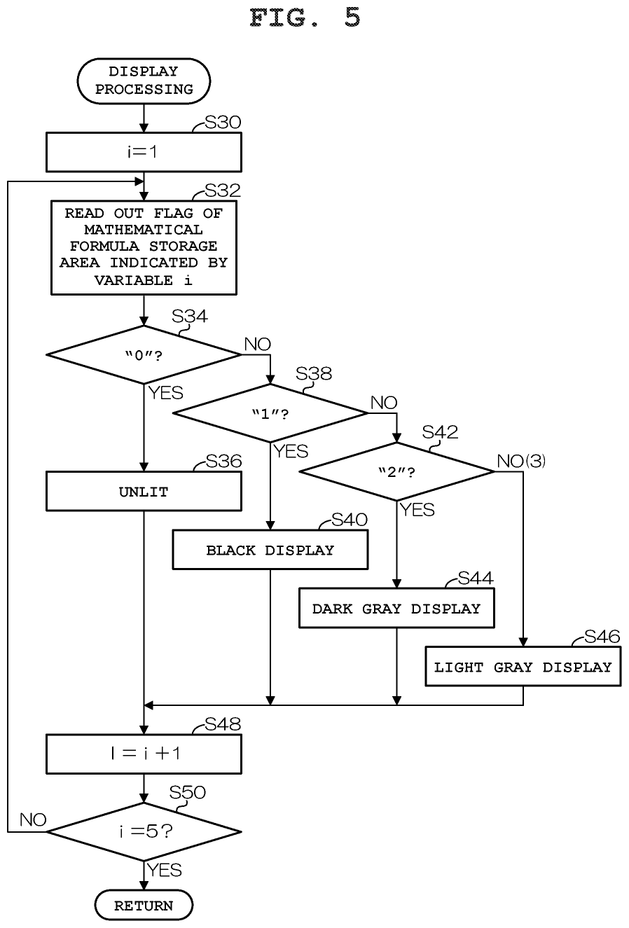

FIG. 5 is a flowchart showing operations of display processing by the electronic device 1 according to the present embodiment. The processor 11 performs display processing shown in FIG. 5 at predetermined time intervals. First, the processor 11 sets variable i which serves as a counter indicating a target mathematical formula storage area 121 to “1” (Step S30). Subsequently, the processor 11 reads out the flag 122 of a mathematical formula storage area 121 indicated by variable i (Step S32).

Next, the processor 11 judges whether or not the flag 122 of the mathematical formula storage area 121 indicated by variable i is “0”, that is, judges whether or not the line corresponding thereto is a blank line (Step S34). When the flag 122 is “0”, that is, when the corresponding line is a blank line (YES at Step S34), the processor 11 turns off the light of the display area of the display 15 corresponding to this line (Step S36).

Conversely, when the flag 122 is not “0”, that is, when the corresponding line is not a blank line (NO at Step S34), the processor 11 judges whether or not the flag 122 is “1”, that is, judges whether or not the corresponding line is an active line (Step S38). When the flag 122 is “1” representing an active line, that is, when input is being performed for the corresponding line (YES at Step S38), the processor 11 displays the display area of the display 15 corresponding to this line in “black” (Step S40).

Conversely, when the flag 122 is not “1”, that is, when the corresponding line is not an active line (NO at Step S38), the processor 11 judges whether or not the flag 122 is “2”, that is, judges whether or not the corresponding line is a semi-active line (whether or not a mathematical formula therein has been used in a mathematical formula in another line) (Step S42). When the flag 122 is “2” representing a semi-active line, that is, when the corresponding line is a line whose mathematical formula has been used in a mathematical formula in another line (YES at Step S42), the processor 11 displays the display area of the display 15 corresponding to this line in “dark grey” (Step S44). Conversely, when the flag 122 is not “2”, that is, when the corresponding line is not a semi-active line (NO at Step S42), the processor 11 judges that the flag 122 is “3”, that is, the corresponding line is an inactive line (a line where no data is currently being inputted and data therein has not been cited), and displays the display area of the display 15 corresponding to this line in “light gray” (Step S46).

After ending the above-described processing of Step S36, Step S40, Step S44, or Step S46, the processor 11 increments variable i by 1 (Step S48), and judges whether or not variable i is “5” (Step S50). When variable i is smaller than “5” (NO at Step S50), the processor 11 returns to Step S32 because there are lines for which the display processing has not been performed, and repeats the above-described display processing on the flag 122 of the next mathematical formula storage area 121. Then, when the processing on the flags 122 of #1 to #4 is ended in this order, variable i reaches “5” (YES at Step S50). Accordingly, the processor 11 ends this display processing (returns to the main routine).

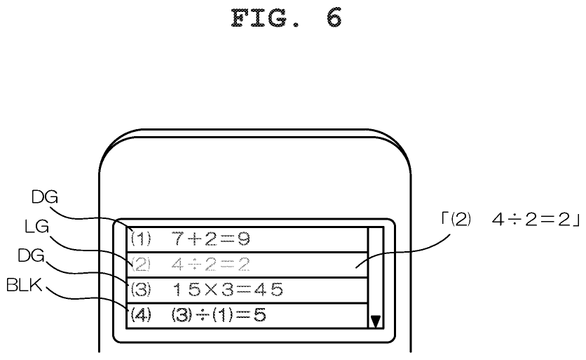

FIG. 6 is a schematic diagram showing an example of a display method for the electronic device 1 according to the present embodiment. Note that, in the drawing, light gray is represented as “LG”, dark grey is represented as “DG”, and black is represented as “BLK” in consideration of visibility. In the example shown in FIG. 6, the first to third lines are lines where mathematical formulas have already been inputted, and the fourth line is a line where a mathematical formula is currently being inputted.

More specifically, because the flag 122 of the mathematical formula storage area 121 of the fourth line is set to “1” by the fourth line being specified as an input line, the mathematical formula and the calculation result “(4) (3)÷(1)=5” in the fourth line are displayed in “black (BLK)” (refer to Step S40). Also, because the mathematical formula in the third line (calculation result (3)) and the mathematical formula in the first line (calculation result (1)) are being used in the fourth line, the flags 122 of the mathematical formula storage areas 121 corresponding to the third line and the first line are set to “2”, and the mathematical formula and the calculation result “(3) 15×3=45” in the third line and the mathematical formula and the calculation result “(1) 7+2=9” in the first line are displayed in “dark grey (DG)”. Moreover, because the second line is not “active” or “semi-active” indicating citation, the flag 122 therefor is set to “3” and the mathematical formula therein is displayed in “light gray (LG)”.

That is, when the four line is specified as an input line, all the flags 122 of the first to third lines are temporarily set to “3” indicating inactive, and the first line to the third line are displayed in “light gray (LG)” (refer to Step S46). Subsequently, when the third line (the calculation result therein) is cited while a mathematical formula is being inputted into the fourth line, the flag 122 of the third line is changed from “3” indicating inactive to “2” indicating semi-active, and the third line is displayed in “dark grey (DG)” (refer to Step S44). Then, when the first line (the calculation result therein) is cited, the flag 122 of the first line is changed from “3” indicating inactive to “2” indicating semi-active, and the first line is displayed in “dark grey (DG)” (refer to Step S44). Note that details of the method for citing mathematical formulas in other lines is described later.

As a result of the above-described configuration, by only viewing the display status of the display 15, the user can easily know a current input status on the basis of differences among displayed gray levels. That is, the user can easily know whether a target field is “active” indicating that a mathematical formula is being inputted thereinto, “semi-active” indicating that a calculation result therein has been used in another mathematical formula, “inactive” indicating that a mathematical formula therein is a previously inputted (calculated) mathematical formula and the calculation result thereof has not been used in another mathematical formula, or “unentered”.

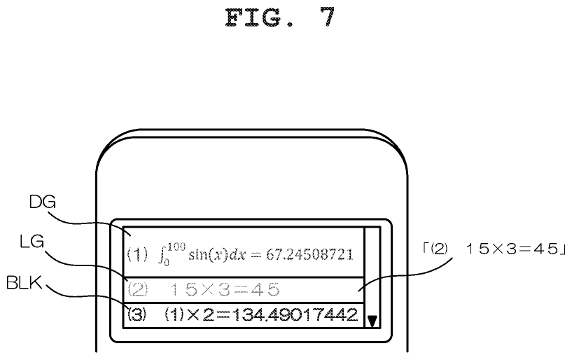

FIG. 7 is also a schematic diagram showing an example of a display method for the electronic device 1 according to the present embodiment. In the present embodiment, in the case of a calculation requiring a large display area, such as an integral equation, display areas can be combined with each other. In the example of the drawing, the first line and the second line have been combined with each other and used as one line. In this case, when the third line is specified as an input line, the flag 122 of the mathematical formula storage area 121 corresponding to the third line is set to “1”, and the mathematical formula and the calculation result in the third line are displayed in “black (BLK)”. Also, by the mathematical formula (calculation result (1)) of the first line being used in the third line, the flag 122 of the mathematical formula storage area 121 corresponding to the first line is set to “1”, and the mathematical formula and the calculation result in the first line is displayed in “dark grey (DG)”. Moreover, by not being “active” or “semi-active” indicating citation, the second line is displayed in “light gray (LG)”.

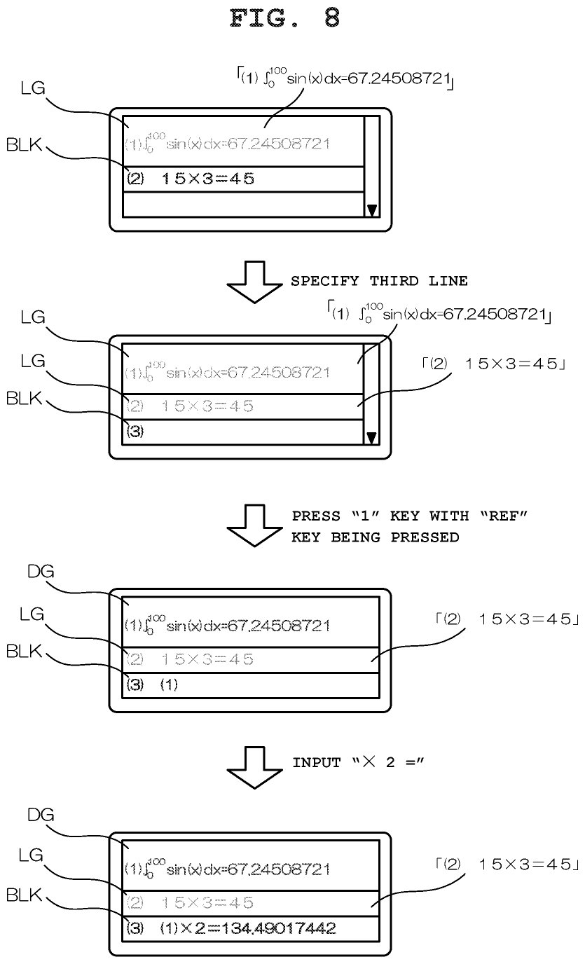

FIG. 8 is a schematic diagram showing a series of operations for inputting a mathematical formula into the electronic device 1 according to the present embodiment. Here, as shown in the uppermost part of the drawing, the first and second lines have been combined with each other to be one line (first line), and have a mathematical formula inputted thereinto. This line is not a line where data is currently being inputted or whose data is being cited, and therefore has been displayed in “light gray (LG)”. Also, the second line has been specified as a current input line and displayed in “black (BLK)”.

When the user specifies the third line as a new input line, the third line is displayed in “black (BLK)”, and the first line (combination line) and the second line are temporarily displayed in “light gray (LG)”.

Next, when the user presses the “1” key while pressing the “REF” key, “(1)” is displayed on the display section, and the mathematical formula (calculation result) of the first line enters a cited state. Accordingly, the first line is displayed in “dark grey (DG)”. The second line is maintained in “light gray (LG)” since this line has not been cited.

Then, when the user inputs the mathematical formula “×2=” into the third line, the calculation result “(1)×2=134.49017442” is displayed in “black (BLK)” in the third line. The first line, which has been cited, is maintained to be displayed in “dark grey (DG)”, and the second line, which is not being used, is maintained to be displayed in “light gray (LG)”.

According to the present embodiment, mathematical formulas can be inputted into a plurality of lines independently. Therefore, even when a mathematical formula is being inputted into a line, another mathematical formula can be inputted into another line. As a result of this configuration, calculation can be easily performed without a previously inputted mathematical formula being deleted. In addition, burdens on the user inputting mathematical formulas can be reduced by the configuration where a calculation result of a mathematical formula can be used in another mathematical formula. Moreover, since inputted mathematical formulas can be stored in the mathematical formula storage areas 121, these mathematical formulas can be easily edited, and recalculation by changes in variables and constants can be easily performed.

In the above-described embodiment, all cited mathematical formulas including the calculation results thereof are displayed in “dark grey”. However, a configuration may be adopted in which these mathematical formulas are displayed in “dark grey” and the calculation results thereof are displayed “black”. With this configuration, cited calculation results can be easily distinguished.

Also, in the above-described embodiment, only calculation results can be cited from mathematical formulas in other lines. However, a configuration may be adopted in which numerical values and the like in the middle of a mathematical formula can be cited. In this configuration, cited numerical values may be displayed in “black” in a cited mathematical formula, and numerical values, symbols, and the like other than the numerical values may be displayed in “dark grey”.

Moreover, in the above-described embodiment, the method by which a plurality of mathematical formulas is displayed at different gray levels has been adopted as a method for varying display forms. However, in the case of a calculator capable of multicolor display, a method may be adopted in which a plurality of mathematical formulas is differentiated by being displayed in different predetermined colors, as long as a mathematical formula such as that currently being inputted or that just inputted in an active line can be distinguished.

In addition, although the method by which a plurality of mathematical formulas is displayed at different gray levels has been adopted as a method for varying display forms in the above-described embodiment, a method may be adopted in which, instead of the gray level expression, mathematical formulas configured to be displayed in “light gray” in the above-described embodiment are configured to blink at predetermined intervals and mathematical formulas configured to be displayed in “dark gray” in the above-described embodiment are configured to blink at different intervals, as long as a mathematical formula such as that currently being inputted or that just inputted in an active line can be distinguished.

According to the above-described embodiment, when a list of a plurality of mathematical formulas is to be displayed by the input of the mathematical formulas being accepted, a first mathematical formula currently being inputted and a second mathematical formula previously inputted are displayed in different forms. As a result of this configuration, the first mathematical formula currently being inputted and the second mathematical formula previously inputted can be easily distinguished from each other, which enhances the user's convenience.

Also, according to the above-described embodiment, the first mathematical formula currently being inputted is displayed at a first gray level, and the second mathematical formula previously inputted is displayed at a second gray level lighter than the first gray level. By this configuration as well, the first mathematical formula currently being inputted and the second mathematical formula previously inputted can be easily distinguished from each other, which enhances the user's convenience.

Moreover, according to the above-described embodiment, when the first mathematical formula currently being inputted and the second mathematical formula previously inputted are to be displayed in different forms, the first mathematical formula is displayed at the first gray level, and the second mathematical formula is displayed at the second gray level if the calculation result of the second mathematical formula has been used in the first mathematical formula, and displayed at a third gray level lighter than the second gray level if the calculation result of the second mathematical formula has not been used in the first mathematical formula. As a result of this configuration, the first mathematical formula currently being inputted, the second mathematical formula previously inputted, and a third mathematical formula which has been used in another mathematical formula can be easily distinguished from one another, which also enhances the user's convenience.

Furthermore, according to the above-described embodiment, the size of a display area is adjusted in accordance with the display size of an accepted mathematical formula. As a result of this configuration, even a complicated mathematical formula which requires a display area larger than that of a general mathematical formula can be displayed, which also enhances the user's convenience.

While the present invention has been described with reference to the preferred embodiments, it is intended that the invention be not limited by any of the details of the description therein but includes all the embodiments which fall within the scope of the appended claims.

What is claimed is:

1. An electronic device comprising at least one processor configured to perform processing including:
inputting a plurality of mathematical formulas in response to operations performed on operation keys;
displaying a list of the plurality of inputted mathematical formulas on a display; and
displaying, in different display forms, a first mathematical formula which is a mathematical formula currently being inputted and a second mathematical formula which is a mathematical formula previously inputted, when displaying the list of the plurality of mathematical formulas.

2. The electronic device according to claim 1, wherein the operation keys include at least numerical keys which are used to input numerical values and symbol keys which are used to input mathematical symbols,
wherein the display is capable of displaying at a plurality of gray levels, and
wherein the processor inputs the first mathematical formula and the second mathematical formula as mathematical formulas including the numerical values inputted by the numerical keys and the mathematical symbols inputted by the symbol keys, and displays the first mathematical formula and the second mathematical formula on the display at different gray levels.

3. The electronic device according to claim 2, wherein the processor displays the first mathematical formula and the second mathematical formula in a manner to be identifiable by displaying the first mathematical formula which is currently being inputted at a first gray level and displaying the second mathematical formula previously inputted at a second gray level lighter than the first gray level.

4. The electronic device according to claim 1, wherein the processor judges whether or not a calculation result of the second mathematical formula has been used in the first mathematical formula, and
wherein the processor, when displaying the first mathematical formula and the second mathematical formula in different display forms, displays the first mathematical formula at a first gray level, and displays the second mathematical formula at a second gray level lighter than the first gray level if the calculation result of the second mathematical formula has been used in the first mathematical formula, or displays the second mathematical formula at a third gray level lighter than the second gray level if the calculation result of the second mathematical formula has not been used in the first mathematical formula.

5. The electronic device according to claim 1, wherein the processor displays the first mathematical formula which is currently being inputted at a first gray level, displays the second mathematical formula previously inputted at a second gray level lighter than the first gray level, and displays a third mathematical formula whose calculation result has been used in the first mathematical formula or the second mathematical formula at a third gray level which is lighter than the first gray level and darker than the second gray level.

6. The electronic device according to claim 5, wherein the processor divides a display area of the display into a plurality of display areas, and displays mathematical formulas displayed on the plurality of display areas at different gray levels.

7. The electronic device according to claim 5, wherein the processor, when controlling the display to display at a plurality of gray levels, controls the display to display using the first gray level, the second gray level, the third gray level, and lights-out by controlling a light of each frame of the display to be turned on and off with three frames that are sequentially displayed as one cycle.

8. The electronic device according to claim 5, further comprising:
a memory having mathematical formula storage areas which store the plurality of mathematical formulas and flag information for identifying input statuses of the plurality of mathematical formulas, and calculation result storage areas which store calculation results of the plurality of mathematical formulas,
wherein the processor controls display of the plurality of mathematical formulas and the calculation results of the plurality of mathematical formulas in accordance with the plurality of mathematical formulas stored in the mathematical formula storage areas and the calculation results of the plurality of mathematical formulas stored in the calculation result storage areas, and displays the plurality of mathematical formulas in different display forms on the basis of the flag information stored corresponding to the plurality of mathematical formulas in the mathematical formula storage areas.

9. The electronic device according to claim 1, wherein the processor adjusts size of a display area of the display in accordance with display size of a mathematical formula inputted by the operation keys.

10. The electronic device according to claim 1, wherein the electronic device is a calculator.

11. A display control method for displaying mathematical formulas on a display, comprising:
controlling a processor of an electronic device to perform processing including:
inputting a plurality of mathematical formulas in response to operations performed on operation keys;
displaying a list of the plurality of inputted mathematical formulas on the display; and
displaying, in different display forms, a first mathematical formula which is currently being inputted and a second mathematical formula previously inputted, when displaying the list of the plurality of mathematical formulas.

12. A non-transitory computer-readable storage medium having stored thereon a program that is executable by a processor of an electronic device to perform processing comprising:
inputting a plurality of mathematical formulas in response to operations performed on operation keys;
displaying a list of the plurality of inputted mathematical formulas on a display; and
displaying, in different display forms, a first mathematical formula which is currently being inputted and a second mathematical formula which is previously inputted, when displaying the list of the plurality of mathematical formulas.
